(19) United States
(12) Patent Application Publication
(10) Pub. No.: US 2013/0335433 A1
(43) Pub. Date: Dec. 19, 2013

(54) SYSTEM AND METHOD FOR MANAGING DATA OF VIDEO CARD

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 13/869,755

(22) Filed: Apr. 24, 2013

(30) Foreign Application Priority Data
Jun. 18, 2012 (TW) 101121699

(51) Int. Cl. G06T 1/60

(52) U.S. Cl. CPC G06T 1/60
USPC 345/547

(57) ABSTRACT

A video card includes a mapping module to map data of the video card from a first video memory into a second video memory. The video card further includes a detection module to detect whether there is a non-working bit in the first video memory or in the second video memory. If there is the non-working bit, a position of the non-working bit is determined. When the non-working bit in the first video memory is accessed, the video card switches to a bit in the second video memory corresponding to the non-working bit. When the non-working bit in the second video memory is accessed, the video card switches to a bit in the first video memory corresponding to the non-working bit.

### BACKGROUND

1. Technical Field

Embodiments of the present disclosure relate to data management technology, and particularly to a system and a method for managing data of a video card.

2. Description of Related Art

Memory of a video card is important for a graphics processing unit (GPU). When the memory of the video card malfunctions, pictures may not be displayed normally and the video card has to be discarded. Thus, it is inconvenient and wasteful for the video card, and is important to detect and repair malfunctions of the memory of the video card.

### BRIEF DESCRIPTION OF THE DRAWINGS

FIG. 1 is a block diagram of one embodiment of a video card including a management system.

FIG. 2 is a block diagram of one embodiment of function modules of the management system in FIG. 1.

FIG. 3 is a flowchart illustrating one embodiment of a method for managing data of a video card.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

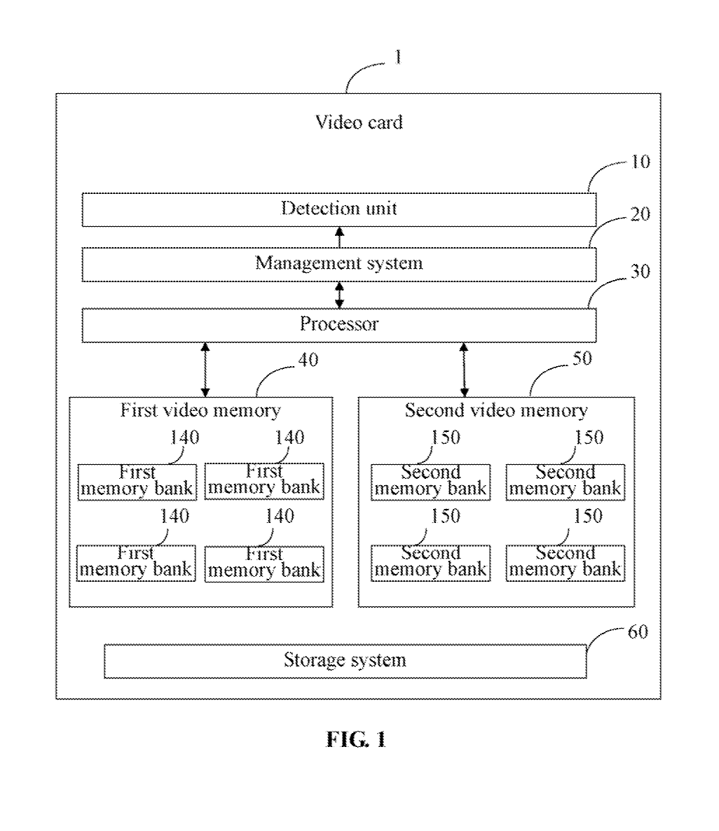

FIG. 1 is a block diagram of one embodiment of a video card 1. The video card 1 includes a detection unit 10, a management system 20, a first video memory 40, and a second video memory 50. The first video memory 40 includes one or more first memory banks 140 and the second video memory 50 includes one or more second memory banks 150. A number of the first memory banks 140 is same as a number of the second memory banks 150. Each of the first memory banks 140 and second memory banks 150 includes a plurality of memory bits. For example, FIG. 1 shows that the first video memory 40 includes four first memory banks 140. In one embodiment, the video card 1 works according to data stored in the first video memory 40 initially. The management system 20 reads data by switching between the first video memory 40 and the second video memory 50 to access normal bits of the memory banks 140,150.

The detection unit 10 detects whether any bit of a first memory bank 140 or a second memory bank 150 is working normally. If the bit cannot be accessed (read or write), the bit is working abnormally. If the bit can be accessed, the bit is working normally. The processor 30 executes one or more computerized codes and other applications for the video card 1, to provide the functions of the management system 20. The video card 1 further includes a storage system 60.

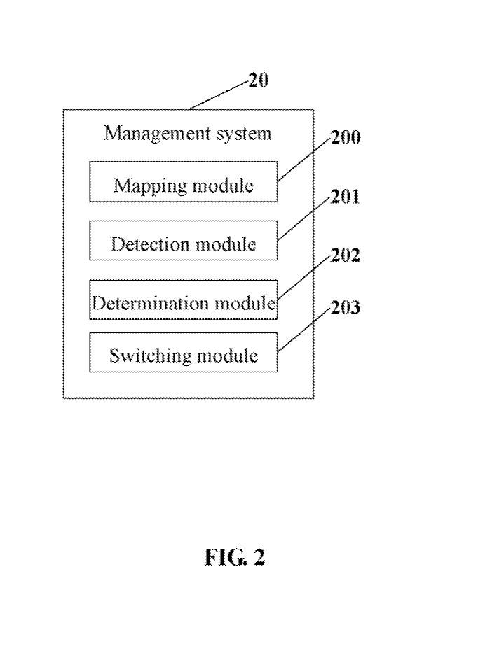

FIG. 2 shows that the management system 20 includes a mapping module 200, a detection module 201, a determination module 202, and a switching module 203. The one or more modules may comprise computerized instructions in the form of one or more programs that are stored in the storage system 60 and executed by the processor 30 to provide functions of the modules 200-203.

The mapping module 200 maps the data in the first video memory 40 to the second video memory 50. After the mapping process, the first video memory 40 and the second video memory 50 store the same data.

The detection module 201 controls the detection unit 10 to detect whether there is a non-working bit in the first video memory 40 or the second video memory 50. The non-working bit cannot be accessed, for example, data stored in the non-working bit cannot be read or data cannot be written into the non-working bit. In one embodiment, one bit of the first video memory 40 or the second video memory 50 is selected, the detection unit 10 sends data to the selected bit, and receives data from the selected bit. If the received data is the same as the sent data, the detection module 201 determines that the selected bit is normal, that is, the selected bit is working normally. If the received data is different from the sent data, the detection module 201 determines that the selected bit is abnormal, that is, the selected bit is the non-working bit. The detection module 201 may send data to each bit of the first video memory 40 and the second video memory 50 to detect whether there is the non-working bit in the first video memory 40 and the second video memory 50. In one embodiment, there may be one or more non-working bits in the first video memory 40 or the second video memory 50.

If there are one or more non-working bits in the first video memory 40, the determination module 202 determines a position of each of the non-working bits in the first video memory 40, that is, the determination module 202 determines one or more first memory banks 140 that include the one or more non-working bits. If there are one or more non-working bits in the second video memory 50, the determination module 202 determines a position of each of the one or more non-working bit in the second video memory 50, that is, the determination module 202 determines one or more second memory banks 150 that include the one or more non-working bits.

When the video card 1 needs to access (e.g. read or write) one of the non-working bits in the first video memory 40, the switching module 203 determines a bit in the second video memory 50 corresponding to the non-working bit in the first video memory 40 according to the position of the non-working bit. The switching module 203 further switches the video card 1 to access the determined bit in the second video memory 50. That is, the non-working bit in the first video memory 40 may not be written or read, and a corresponding bit (e.g., the determined bit as mentioned above) in the second video memory 50 is written or read instead.

When the video card 1 needs to access one of the non-working bits in the second video memory 50, the switching module 203 determines a bit in the first video memory 40 corresponding to the non-working bit in the second video memory 50 according to the position of the non-working bit. The switching module 203 further switches the video card 1 to access the determined bit in the first video memory 40.

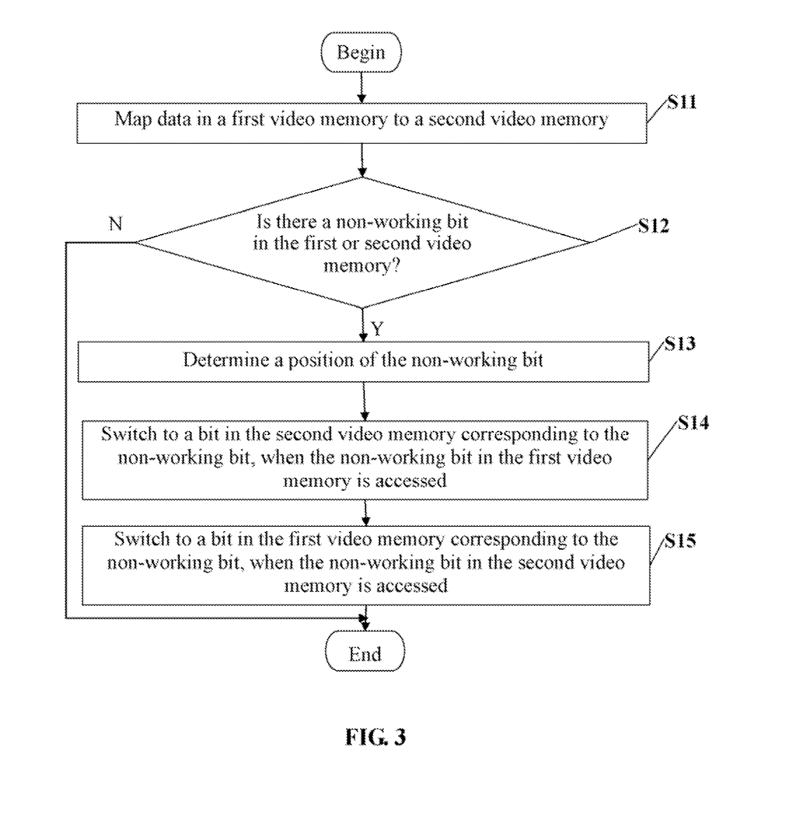

FIG. 3 is a flowchart illustrating a method for managing data of a video card 1 in FIG. 1. Depending on the embodiment, additional steps may be added, others removed, and the ordering of the steps may be changed.

In step S11, the mapping module 200 maps the data in the first video memory 40 to the second video memory 50. After the mapping process, the first video memory 40 and the second video memory 50 stores the same data.

In step S12, the detection module 201 controls the detection unit 10 to detect whether there is a non-working bit in the first video memory 40 or in the second video memory 50. If there are one or more non-working bits in the first video memory 40 or in the second video memory 50, step S13 is implemented. If there is no non-working bit in the first video memory 40 and in the second video memory 50, procedure ends.

In step S13, the determination module 202 determines a position of each of the one or more non-working bits in the first video memory 40 and in the second video memory 50.

In step S14, When the video card 1 needs to access (e.g. read or write) one of the non-working bits in the first video memory 40, the switching module 203 determines a bit in the second video memory 50 corresponding to the non-working bit in the first video memory 40 according to the position of the non-working bit, and switches the video card 1 to access the determined bit in the second video memory 50

In step S15, When the video card 1 needs to access one of the non-working bits in the second video memory 50, the switching module 203 determines a bit in the first video memory 40 corresponding to the non-working bit in the second video memory 50 according to the position of the non-working bit, and switches the video card 1 to access the determined bit in the first video memory 40.

All of the processes described above may be embodied in, and be fully automated via, functional code modules executed by one or more general-purpose processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A video card, comprising:
a first video memory comprising one or more first memory banks;
a second video memory comprising one or more second memory banks;
a storage system;
at least one processor for executing one or more programs stored in the storage system to perform a method of managing data of the video card, comprising:
mapping data in the first video memory to the second video memory;
detecting whether there is a non-working bit in the first video memory or in the second video memory;
determining a position of the non-working bit in the first video memory or the second video memory;
switching the video card to access a bit in the second video memory corresponding to the non-working bit according to the position of the non-working bit, when the video card accesses the non-working bit in the first video memory; or switching the video card to access a bit in the first video memory corresponding to the non-working bit according to the position of the non-working bit, when the video card accesses the non-working bit in the second video memory.

2. The video card as described in claim 1, wherein determining the position of the non-working bit in the first video memory or the second video memory is by:
controlling the video card to send data to a selected bit of the first video memory and the second video memory, and to receive data from the selected bit;
determining that the selected bit is normal if the received data is the same as the sent data;
or determining that the selected bit is the non-working bit if the received data is different from the sent data.

3. The video card as described in claim 1, wherein a number of the one or more first memory banks is same as a number of the one or more second memory banks.

4. A method being executed by a processor of a video card for managing data of a video card, comprising:
mapping data in a first video memory of the video card into a second video memory of the video card;
detecting whether there is a non-working bit in the first video memory or in the second video memory;
determining a position of the non-working bit in the first video memory or in the second video memory, if there is the non-working bit in the first video memory or in the second video memory;
switching the video card to access a bit in the second video memory corresponding to the non-working bit according to the position of the non-working bit, when the video card accesses the non-working bit in the first video memory; or
switching the video card to access a bit in the first video memory corresponding to the non-working bit according to the position of the non-working bit, when the video card accesses the non-working bit in the second video memory.

5. The method as described in claim 4, wherein determining the position of the non-working bit in the first video memory or the second video memory is by:
controlling the video card to send data to a selected bit of the first video memory and the second video memory, and to receive data from the selected bit;
determining that the selected bit is normal if the received data is the same as the sent data;
or determining that the selected bit is the non-working bit if the received data is different from the sent data.

6. The method as described in claim 4, wherein a number of one or more first memory banks in the first video memory is same as a number of one or more second memory banks in the second video memory.

7. A non-transitory storage medium having stored thereon instructions that, when executed by a processor, causes the processor to perform a method for managing data of a video card, the method comprising:
mapping data in a first video memory of the video card to a second video memory of the video card;
detecting whether there is a non-working bit in the first video memory or in the second video memory;
determining a position of the non-working bit in the first video memory or in the second video memory, if there is the non-working bit in the first video memory or in the second video memory;
switching the video card to access a bit in the second video memory corresponding to the non-working bit according to the position of the non-working bit, when the video card accesses the non-working bit in the first video memory; or
switching the video card to access a bit in the first video memory corresponding to the non-working bit according to the position of the non-working bit, when the video card accesses the non-working bit in the second video memory.

8. The non-transitory storage medium as described in claim 7, wherein determining the position of the non-working bit in the first video memory or the second video memory is by:
controlling the video card to send data to a selected bit of the first video memory and the second video memory, and to receive data from the selected bit;
determining that the selected bit is normal if the received data is the same as the sent data;
or determining that the selected bit is the non-working bit if the received data is different from the sent data.

9. The non-transitory storage medium as described in claim 7, wherein a number of one or more first memory banks in the first video memory is same as a number of one or more second memory banks in the second video memory.
